(19) United States
(12) Patent Application Publication
(10) Pub. No.: US 2007/0109632 A1
(43) Pub. Date: May 17, 2007

(54) Optical pickup apparatus

(75) Inventors: Kei Imai, Daito (JP); Tetsuo Nishidate, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/598,795

(22) Filed: Nov. 14, 2006

(30) Foreign Application Priority Data
Nov. 14, 2005 (JP) 2005-328671

(51) Int. Cl. G02B 21/00

(52) U.S. Cl. 359/368

(57) ABSTRACT

There is provided an optical pickup apparatus whereby the phase of a grating can be adjusted sufficiently even while further reducing the number of parts. A plate spring portion 12b formed in a bent manner is provided in the front part of a cover 12. The plate spring portion is composed of an annular plate-like portion 12ba having an outside diameter approximately the same as the diameter of a grating 3 and formed with a through hole “h” for passage of laser beams through the center axis and a connecting portion 12bb for connecting the edge portion of the plate-like portion 12ba and the front end of the cover 12. Therefore, the connecting portion 12bb is to be deformed elastically by loading in the axial direction with respect to the plate-like portion 12ba to serve as a so-called plate spring. As for the plate spring portion 12b, the connecting portion 12bb is deformed elastically and the plate-like portion 12ba is in contact with the grating 3, whereby the elastic force of the connecting portion 12bb is applied to the grating 3 in the axial direction.

### BACKGROUND OF THE INVENTION

1. Field of the Invention

The present invention relates to an optical pickup apparatus for recording/reproducing various information onto/from an information recording medium such as a CD or a DVD, particularly in which the assembling structure of a grating to be incorporated for generation of a focusing error signal and/or a tracking error signal is improved.

2. Description of the Prior Art

In general, the optical system of optical pickup apparatuses is basically composed of: a columnar LD (Laser Diode) for emitting a laser beam; a columnar resin grating for diffracting the laser beam from the LD; an objective lens for focusing the diffracted light from the grating on an optical disk; and a photodetector for receiving the returning light from the optical disk through the objective lens. Among these components, the LD and grating are assembled onto a base portion that constitutes a part of the optical pickup apparatus main body to form an integrated light source unit from the viewpoint of mainly stabilizing the emitting direction of the laser beam (diffracted light).

In the case above, in order that the positions of the optical components can be adjusted mutually, the grating is attached to the base portion in such a manner, for example, as to be movable in the optical axis direction of the laser beam and rotatable around the optical axis, and then is fixed to the base portion by adhesive, etc. after the position in the optical axis direction and the rotational position are adjusted. Here, Japanese Patent Laid-Open Publication No. 2000-285494 discloses an optical pickup apparatus having a mechanism capable of adjusting the phase of a grating for diffracting an emitted laser beam easily and precisely.

Specifically, in an optical pickup apparatus having: a grating for diffracting a laser beam emitted from a laser light source; a holder to which the grating is fixed; a housing portion in an apparatus frame in which the holder is housed movably; and a coil spring pressing and fixing the holder against the housing portion, a spacer is sandwiched between the holder and the coil spring.

Then, in this configuration, the spacer prevents the coil spring from coming into contact with the holder, whereby the elastic restoring force of the coil spring cannot be transferred to the holder and it can also be prevented that the end of the coil spring is caught in irregularities on the end face of the holder. This therefore results in allowing adverse effects due to the coil spring to be prevented.

However, allowing for such a phase adjustment requires at least a spacer and a coil spring separately, resulting in a problem of forcing complicated parts control and/or assembly operations as well as of insufficiently responding to the requirement of cost reduction. Hence, Japanese Patent Laid-Open Publication No. 2004-22034 discloses an optical pickup apparatus whereby the phase of a grating can be adjusted sufficiently while reducing the number of parts to suppress complicated parts control and/or assembly operations as well as to respond to the requirement of cost reduction.

Specifically, in an optical pickup apparatus having a housing recessed portion in which a columnar grating for diffracting a laser beam, an elastic body for pressing the grating in the axial direction, and an LD for supporting the elastic body and for emitting the laser beam are inserted in this order, the elastic body is formed by integrally molding a plate-like portion formed with a through hole for passing the laser beam therethrough and in contact with the front surface of the grating and a plurality of protruding pieces protruding symmetrically from the edge portion of the plate-like portion to be deformed elastically and brought into contact with the front surface of the LD.

FIG. 6 is a disassembled plan view showing an example of the mounting structure of a grating in such a conventional optical pickup apparatus having an elastic body formed by integrally molding a plate-like portion and protruding pieces. In this figure, the numeral 101 indicates a base generally composed of molded parts by die-casting, etc. on which a plurality of optical components of the optical pickup apparatus such as a beam splitter and various lenses are mounted. However, the plurality of optical components are not shown in the figure.

In the front part of the base 101, there is provided a recessed portion 101a, in which an approximately columnar grating 102 is inserted. G spring 103 corresponding to the above-described elastic body is incorporated concentrically from the front of the grating 102 and further is pressed and fixed by an LD spring 104 from the front thereof. The LD spring 104 is a sheet metal part having an approximately U shape when viewed from side, into which a holder not shown in the figure is to be fitted. An LD not shown in the figure is held in the holder and is arranged concentrically with the grating 102 and G spring 103.

The G spring 103 is made from a metal plate such as SUS and, as shown in the front and plan views of FIGS. 7(a) and 7(b), is formed by integrally molding an annular plate-like portion 103a having an outside diameter approximately the same as the diameter of the grating 102 and formed with a through hole “h” for passage of laser beams through the center axis and a pair of protruding pieces 103b protruding from the edge portion of the plate-like portion 103a in a bent manner. Therefore, each protruding piece 103b is to be deformed elastically by loading in the axial direction with respect to the plate-like portion 103a to serve as a so-called plate spring.

Meanwhile, the grating 102 is adapted to diffract a laser beam transmitting through the vicinity of the center axis thereof, and a groove for inserting therein an adjusting jig for phase adjustment is formed in the outer peripheral surface of the grating 102 in the axial direction (not shown in the figure). FIG. 8 is a view showing an example of such an adjusting jig, where FIG. 8(a) is a front view and FIG. 8(b) is a bottom view. The adjusting jig 105 has a rod shape including a relatively thick grip portion 105a and rods 105b and 105c extending from the grip portion while getting thin by two steps, and an eccentric pin 105d is provided at the leading end of the rod 105c.

Referring again to FIG. 6, the protruding pieces 103b of the G spring 103 are deformed elastically with the foregoing components being mounted on the base 101 so that the leading end portions thereof are brought into contact with the LD spring 104 and that the plate-like portion 103a is brought into contact with the grating 102, whereby the elastic forces of the protruding pieces 103b are applied to the grating 102 in the axial direction. Therefore, the grating 102 is pressed against the bottom surface of the recessed portion 101a so that the axial movement thereof is restricted and is held rotatably around the axis, which allows for phase adjustment.

Then, the phase adjustment is achieved by inserting the above-described rod-shaped adjusting jig 105 into a through hole 101b that penetrates from the upper surface of the base 101 to the recessed portion 101a, inserting the eccentric pin 105d into the foregoing groove in the grating 102, and rotating the adjusting jig 105 directly to swivel the eccentric pin 105d so that the grating 102 is rotated around the axis. In this case, the grating 102 and the plate-like portion 103a are in contact with each other and slide smoothly against each other, where the plate-like portion 103a and the grating 102 have approximately the same diameter, which makes it possible to keep a uniform contact state and also stabilizes the mutual sliding therebetween.

In addition, an approximately flat plate-like cover 106 is fixed to the upper surface of the base 101. This is achieved by fitting and positioning a positioning hole 106a opened at a corner of the cover 106 against a positioning pin 101c protruding from the upper surface of the base 101 and then screwing a screw 107 into a screw hole 101d provided in the vicinity of the positioning pin 101c through a fitting hole 106b provided in the vicinity of the positioning hole 106a. This allows the cover 106 to be fixed onto the upper surface of the base 101.

However, such a conventional arrangement as shown in FIG. 6 still requires an elastic member (G spring 103) for urging a grating and forces complicated assembly operations such as fixing an LD while holding the elastic member by the hands of an operator, resulting in poor productivity.

### SUMMARY OF THE INVENTION

The present invention has been made in consideration of the above-described problems, and an object thereof is to provide an optical pickup apparatus whereby the phase of a grating can be adjusted sufficiently even while further reducing the number of parts.

In order to achieve the foregoing object, the present invention is directed to an optical pickup apparatus including: a base having a cover; a grating for diffracting a laser beam; a housing recessed portion provided in the base to house the grating movably; and an elastic body for pressing and fixing the grating against the housing recessed portion, wherein the elastic body is molded integrally with the cover.

Also, the elastic body is characterized by including: an annular plate-like portion having an outside diameter approximately the same as the diameter of the grating and in contact with the grating; and a connecting portion for connecting the edge portion of the plate-like portion and the end portion of the cover.

Alternatively, the elastic body is characterized by including: a U-shaped plate-like portion having a width approximately the same as the diameter of the grating with the leading ends thereof being in contact with the grating; and a connecting portion for connecting the edge portion of the plate-like portion and the end portion of the cover.

In accordance with the present invention, it is possible to provide an optical pickup apparatus whereby the phase of a grating can be adjusted sufficiently even while further reducing the number of parts.

Specifically, the assembly operations are facilitated while reducing the number of parts by molding the elastic body for pressing the grating in the axial direction integrally with the cover of the base, and further the optical pickup apparatus whereby the phase of the grating can be adjusted sufficiently is achieved.

### BRIEF DESCRIPTION OF THE DRAWINGS

FIG. 1 is a schematic block diagram showing the optical system of an optical pickup apparatus according to the present invention;

FIG. 2 is a view showing the mounting structure of a grating in an optical pickup apparatus according to a first embodiment of the present invention;

FIG. 3 is a view showing the shape of a cover according to the first embodiment;

FIG. 4 is a view showing the mounting structure of a grating in an optical pickup apparatus according to a second embodiment of the present invention;

FIG. 5 is a view showing the shape of a cover according to the second embodiment;

FIG. 6 is a disassembled plan view showing an example of the mounting structure of a grating in a conventional optical pickup apparatus;

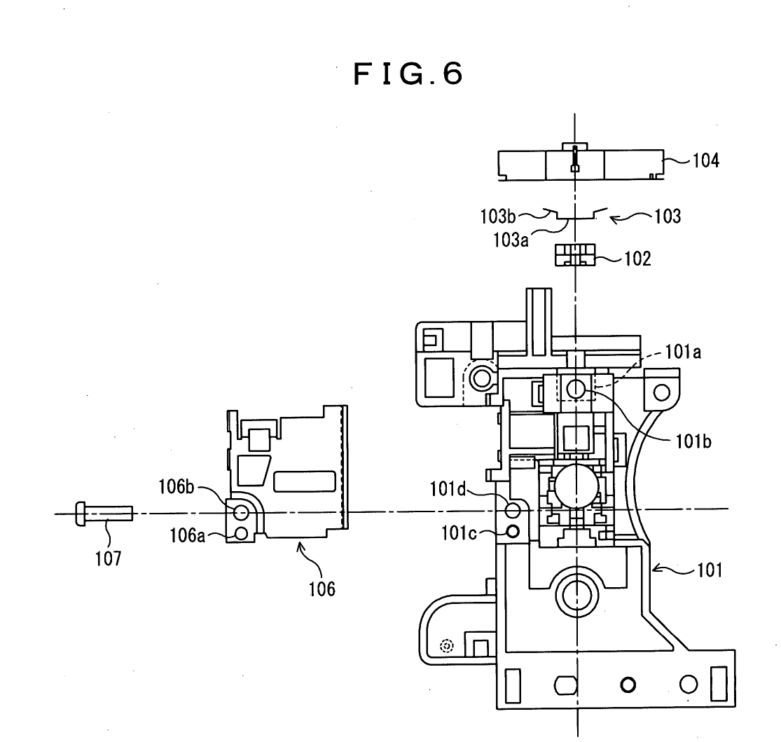

FIG. 7 is a view showing the shape of a G spring as a conventional elastic body; and

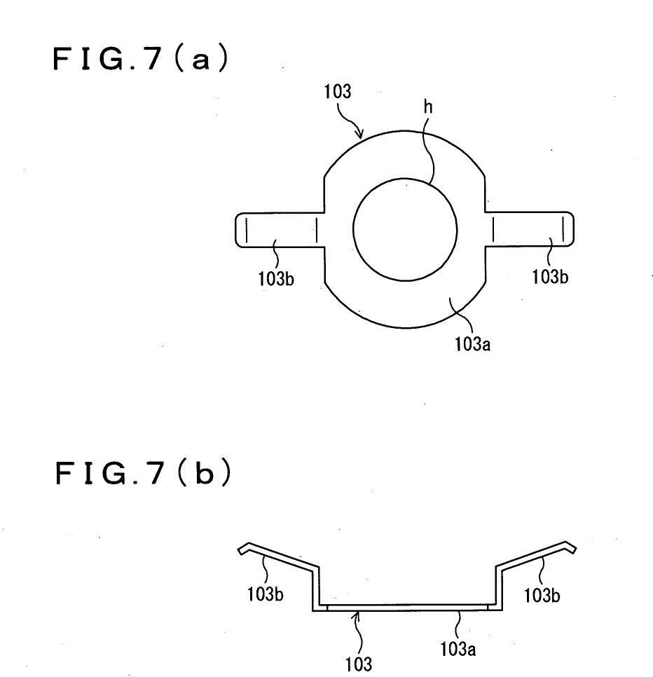

FIG. 8 is a view showing an example of an adjusting jig.

### DESCRIPTION OF THE PREFERRED EMBODIMENTS

Embodiments of the present invention will hereinafter be described with reference to the accompanying drawings.

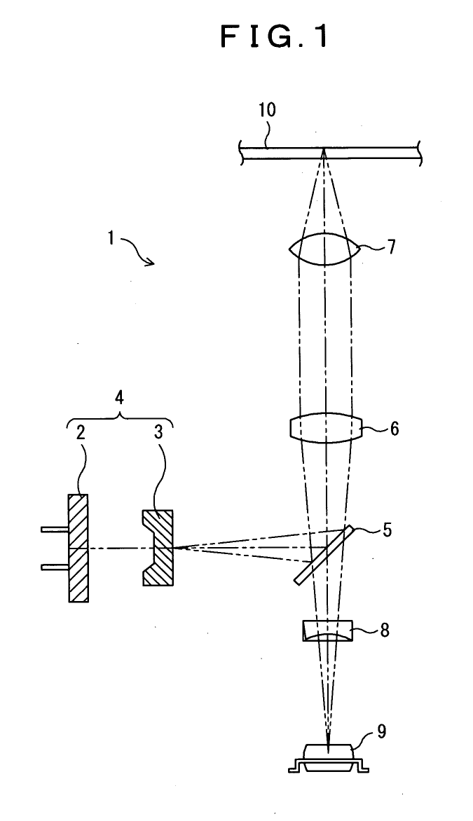

FIG. 1 is a schematic block diagram showing the optical system of an optical pickup apparatus according to the present invention. As shown in this figure, the optical system of the optical pickup apparatus 1 is composed of: a light source unit 4 including an LD (Laser Diode) 2 and a grating 3; a beam splitter 5 such as a half mirror or a prism for reflecting a laser beam (diffracted light) emitted from the light source unit 4 toward an optical disk 10 and for transmitting returning light from the optical disk 10 therethrough; a collimator lens 6 for converting the reflected light from the beam splitter 5 into parallel light; an objective lens 7 for focusing the parallel light from the collimator lens 6 on the recording surface of the optical disk 10; and a photodetector 9 for receiving the returning light from the optical disk 10 through the beam splitter 5 and a sensor lens 8.

### First Embodiment

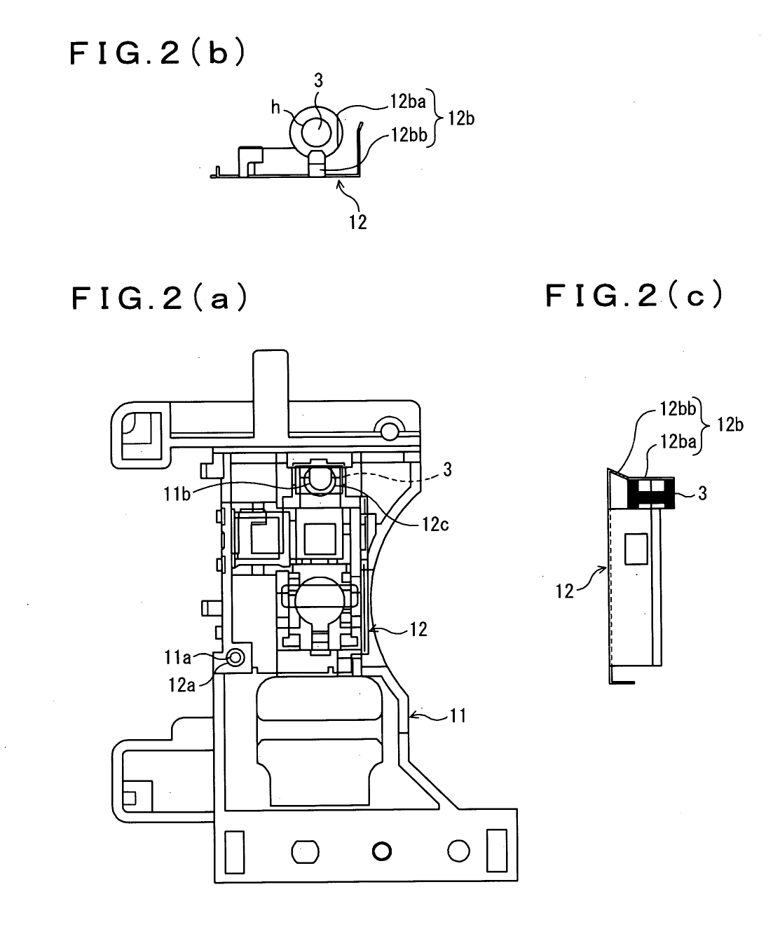

FIG. 2 is a view showing the mounting structure of a grating in an optical pickup apparatus according to a first embodiment of the present invention, where FIG. 2(a) is a plan view, FIG. 2(b) is a front view, and FIG. 2(c) is a side view. FIG. 2(a) shows a base seen through a cover. Also, FIGS. 2(b) and 2(c) show only a cover and a grating. In this figure, the numeral 11 indicates a base generally composed of molded parts by die-casting, etc. on which a plurality of optical components of the optical pickup apparatus such as a beam splitter and various lenses are mounted. However, the plurality of optical components are not shown in the figure.

In the front part of the base 11, there is provided a recessed portion, in which an approximately columnar grating 3 is inserted. Also, an approximately flat plate-like cover 12 made from a metal plate such as SUS is fixed to the upper surface of the base 11. This is achieved by screwing a screw not shown in the figure into a screw hole 11a provided in the upper surface of the base 11 through a fitting hole 12a opened at a corner of the cover 12. This allows the cover 12 to be fixed onto the upper surface of the base 11. The positional relationship between the grating 3 and an LD not shown in the figure is the same as in the above-described conventional arrangement.

Now, in the present embodiment, a plate spring portion 12b formed in a bent manner is provided in the front part of the cover 12. The plate spring portion is composed of an annular plate-like portion 12ba having an outside diameter approximately the same as the diameter of the grating 3 and formed with a through hole “h” for passage of laser beams through the center axis and a connecting portion 12bb for connecting the edge portion of the plate-like portion 12ba and the front end of the cover 12. Therefore, the connecting portion 12bb is to be deformed elastically by loading in the axial direction with respect to the plate-like portion 12ba to serve as a so-called plate spring.

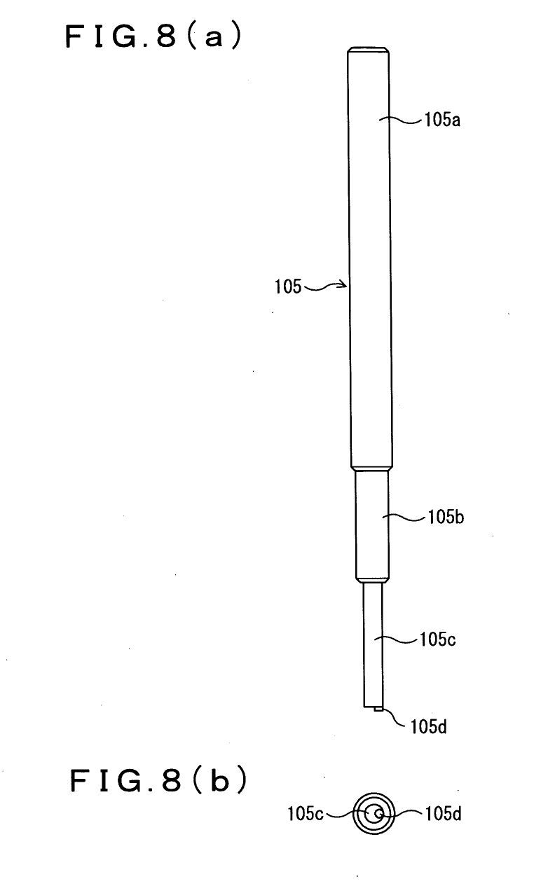

Meanwhile, the grating 3 is adapted to diffract a laser beam transmitting through the vicinity of the center axis thereof, and a groove for inserting therein an adjusting jig for phase adjustment is formed in the outer peripheral surface of the grating 3 in the axial direction (not shown in the figure). The adjusting jig to be used is the same as shown in FIG. 8. As for the plate spring portion 12b, the connecting portion 12bb is deformed elastically and the plate-like portion 12ba is in contact with the grating 3, whereby the elastic force of the connecting portion 12bb is applied to the grating 3 in the axial direction.

Therefore, the grating 3 is pressed against the bottom surface of the recessed portion not shown in the figure, which is provided in the base 11, so that the axial movement thereof is restricted and is held rotatably around the axis, which allows for phase adjustment. Then, the phase adjustment is achieved by inserting the above-described adjusting jig into a hole 12c that is provided in the front part of the cover 12 and into a notch portion 11b that is provided at the front end of the base 11, inserting the eccentric pin into the foregoing groove in the grating 3, and rotating the adjusting jig directly to swivel the eccentric pin so that the grating 3 is rotated around the axis.

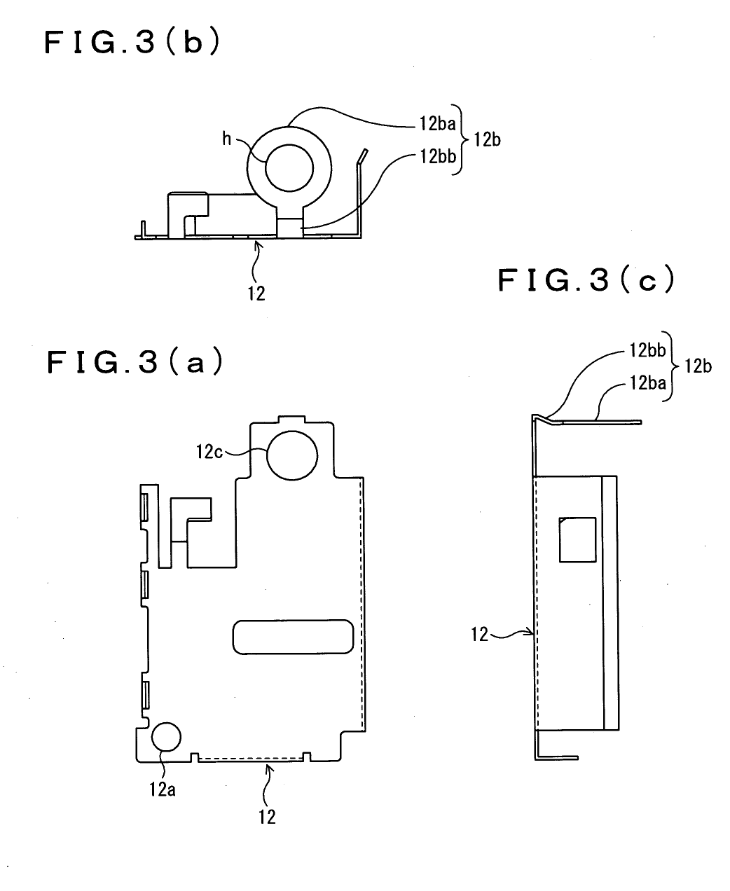

In this case, the grating 3 and the plate-like portion 12ba are in contact with each other and slide smoothly against each other, where the plate-like portion 12ba and the grating 3 have approximately the same diameter, which makes it possible to keep a uniform contact state and also stabilizes the mutual sliding therebetween. Here, the shape of the cover 12 is shown in FIG. 3, where FIG. 3(a) is a plan view, FIG. 3(b) is a front view, and FIG. 3(c) is a side view.

### Second Embodiment

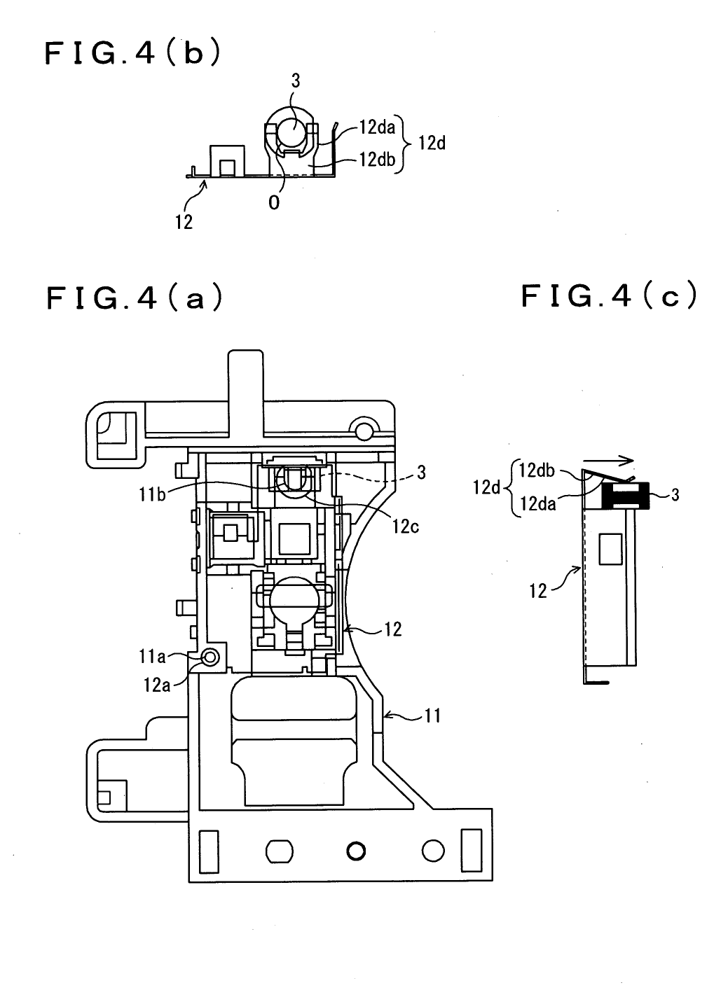

FIG. 4 is a view showing the mounting structure of a grating in an optical pickup apparatus according to a second embodiment of the present invention, where FIG. 4(a) is a plan view, FIG. 4(b) is a front view, and FIG. 4(c) is a side view. FIG. 4(a) shows a base seen through a cover. Also, FIGS. 4(b) and 4(c) show only a cover and a grating. The basic configuration of the present embodiment is the same as that of the above-described first embodiment, except that the shape of a plate spring portion to be provided in the front part of the cover is different.

Now, in the present embodiment, a plate spring portion 12d formed in a bent manner is provided in the front part of the cover 12. The plate spring portion is composed of a U-shaped plate-like portion 12da having a width approximately the same as the diameter of the grating 3 and formed with an opening “o” for passage of laser beams through the center thereof and a connecting portion 12db for connecting the edge portion of the plate-like portion 12da and the front end of the cover 12. Therefore, the connecting portion 12db is to be deformed elastically by loading in the axial direction with respect to the plate-like portion 12da to serve as a so-called plate spring.

The leading ends of the plate-like portion 12da are bent into an approximately V shape when viewed from side, the bent portions being adapted to press approximately the center of the grating 3 when viewed from side. Thus, the grating 3 is pressed approximately uniformly against the bottom surface of the recessed portion not shown in the figure, which is provided in the base 11, so that the axial movement thereof is restricted and is held rotatably around the axis, which allows for stable phase adjustment.

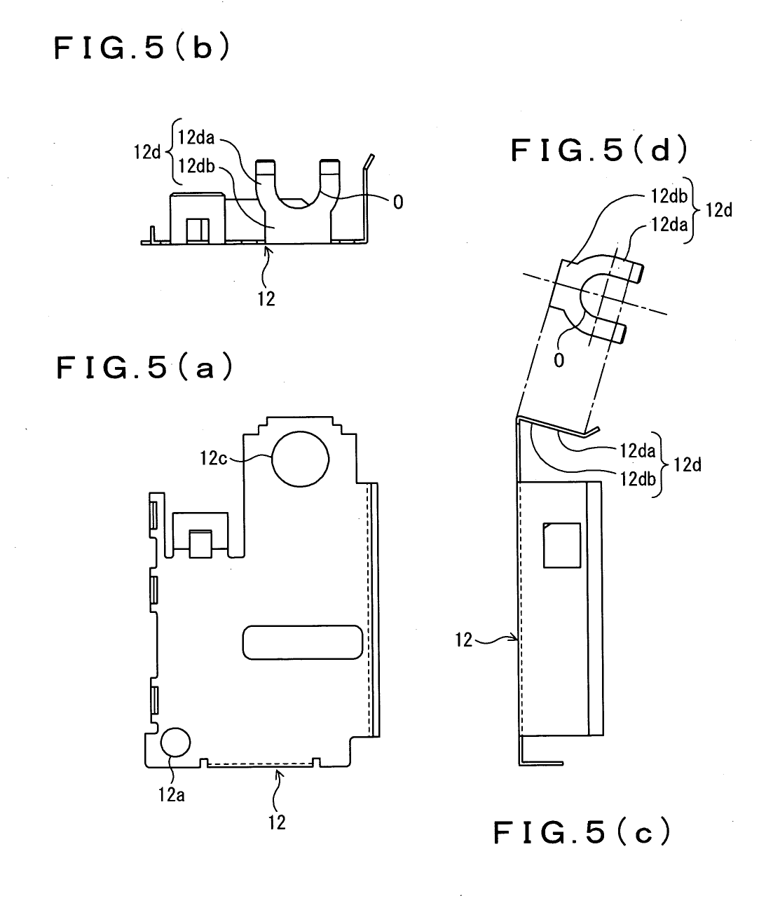

Further, since the leading ends of the plate-like portion 12da are bent, the leading ends of the plate-like portion 12da cannot be caught on the grating 3 even when slid as indicated by the arrow in FIG. 4(c) to fit the cover 12 to the base 11. Here, the shape of the cover 12 is shown in FIG. 5, where FIG. 5(a) is a plan view, FIG. 5(b) is a front view, FIG. 5(c) is a side view, and FIG. 5(d) is an auxiliary projection view of the plate spring portion.

As described heretofore, in accordance with the present invention, the assembly operations are facilitated while reducing the number of parts by molding the elastic body for pressing the grating in the axial direction integrally with the cover of the base, and further the optical pickup apparatus whereby the phase of the grating can be adjusted sufficiently is achieved.

What is claimed is:

1. An optical pickup apparatus comprising: a base having a cover; a grating for diffracting a laser beam; a housing recessed portion provided in said base to house said grating movably; and an elastic body for pressing and fixing said grating against said housing recessed portion, wherein
said elastic body is molded integrally with said cover, said elastic body comprising: an annular plate-like portion having an outside diameter approximately the same as the diameter of said grating and in contact with said grating or a U-shaped plate-like portion having a width approximately the same as the diameter of said grating with the leading ends thereof being in contact with said grating; and a connecting portion for connecting the edge portion of said plate-like portion and the end portion of said cover, and wherein
said connecting portion is adapted to be deformed elastically by loading in the axial direction with respect to said plate-like portion.

2. An optical pickup apparatus comprising: a base having a cover; a grating for diffracting a laser beam; a housing recessed portion provided in said base to house said grating movably; and an elastic body for pressing and fixing said grating against said housing recessed portion, wherein said elastic body is molded integrally with said cover.

3. The optical pickup apparatus according to claim 2, wherein said elastic body comprises: an annular plate-like portion having an outside diameter approximately the same as the diameter of said grating and in contact with said grating; and a connecting portion for connecting the edge portion of said plate-like portion and the end portion of said cover.

4. The optical pickup apparatus according to claim 2, wherein said elastic body comprises: a U-shaped plate-like portion having a width approximately the same as the diameter of said grating with the leading ends thereof being in contact with said grating; and a connecting portion for connecting the edge portion of said plate-like portion and the end portion of said cover.
